(19) United States
(12) Patent Application Publication
(10) Pub. No.: US 2019/0206580 A1
(43) Pub. Date: Jul. 4, 2019

(54) SMALL MODULAR REACTOR POWER PLANT WITH LOAD FOLLOWING AND COGENERATION CAPABILITIES AND METHODS OF USING

(71) Applicant: Advanced Reactor Concepts LLC, Chevy Chase, MD (US)

(72) Inventors: Leon C. WALTERS, Idaho Falls, ID (US); David WADE, Plano, IL (US)

(73) Assignee: Advanced Reactor Concepts LLC, Chevy Chase, MD (US)

(21) Appl. No.: 15/757,599

(22) PCT Filed: Dec. 11, 2017
(86) PCT No.: PCT/US2017/065634

§ 371 Date: Mar. 5, 2018

Related U.S. Application Data
(60) Provisional application No. 62/432,668, filed on Dec. 11, 2016.

(51) Int. Cl. G21D 1/02; G21D 3/14; G21C 3/38; G21C 3/06; G21C 19/20

(52) U.S. Cl. CPC G21D 1/02; G21D 3/14; G21C 19/205; G21C 3/06; G21C 3/38

(57) ABSTRACT

Provided herein is a small modular nuclear reactor plant that can comprise a reactor core comprising a primary sodium comprising cool primary sodium flow and heated primary sodium flow. Heated primary sodium flow can enter one or more IHXs where heated primary sodium exchanges heat with secondary sodium flowing through at least one intermediate sodium loop. Intermediate sodium loop can comprise secondary sodium flow that can transport heat to energy conversion portion via a heat exchanger. Energy conversion portion can comprise a bypass valve. Bypass valve can bypass an energy conversion working fluid (such as S-CO2) away from a turbine during periods of adjustment as discussed herein. The plant may comprise passive load following features along with the ability to provide cogeneration heat.

### BACKGROUND

Nuclear energy is one of the non-carbon-emitting sources for electricity production available for future deployments worldwide. Customer needs differ from nation to nation. In developing country nations (which lack indigenous nuclear fuel cycle infrastructure such as enrichment facilities), customers seek plants that offer energy security at affordable initial cost. Alternately, industrial nations face impending end of life of the light-water reactor (LWR) fleets deployed in the 1970s and 80s as well as decommissioning of coal plants (in the face of tightening carbon emission standards). With extensive interconnected grids already in place, but with a growing contribution of intermittent “renewables” sources in its supply mix, industrialized nation customers need non carbon-emitting plants to provide load following capability that also attain a low levelized cost of energy (LCOE).

Societies utilize energy delivered in two forms—electricity and heat—in roughly equal proportions. When heat is converted to electricity in a heat engine, significantly less than 100% conversion is achieved—even in the best converters, the unconverted (reject) heat is about half of the total, and it must be disposed in a way not harmful to the environment. If this reject heat's temperature is in a useful range (i.e., sufficiently above ambient temperature), then, in contrast to dumping it into the environment, it can be put to revenue-generating use by installing “bottoming cycles” on the energy converter's heat rejection equipment to transport the heat offsite to a productive application. The power plant then becomes a “cogeneration plant”—delivering both electricity and heat for societal use.

Even though heat supply potential from power stations is huge, very few nuclear power plants have previously been equipped for cogeneration, owing to several barriers—

i)—the reject heat is at too low a temperature above ambient to have useful societal applications;
ii)—the cogeneration mission would reduce electricity sales revenue;
iii)—the bottoming cycle might affect nuclear reactor safety posture;
iv)—radioactivity might carry over to the fluid streams of the cogeneration equipment;
v)—the limited transport distance of heat would require reactor siting too near to population centers to be acceptable from a licensing point of view; and
vi)—the cogeneration application might constrain or complicate power production

These barriers are seen to include technical, business and institutional considerations.

As intermittent solar and wind sources become significant contributors to future electrical grid supply while at the same time fossil fuel burning plants become less significant contributors, needs exist for nuclear power plants in the small modular reactor (SMR) class possessing a “load following” mode of operation. Load following can refer to the process of altering a power plant's (in this case a nuclear power plant) output power based on the needs of a power grid. Additionally, in developing economies, the power grid may be local and/or small and the SMR plant might constitute the main source to the grid. In that case, it must load follow the daily cycle of demand.

Prior art nuclear power plants are not well suited for efficiently load following and would not be incentivized to load follow because typically nuclear power plants are designed and optimized to run at full power principally because unlike fossil-fueled plants, the fuel costs for a nuclear plant are sunk at the time of construction and are not a variable expense. Load following has thus been cost-discouraged from a financial standpoint. Also, prior art nuclear power plants are susceptible to structural fatigue loadings under load following operations because of the thermomechanical stresses produced. These shortcomings have been exacerbated by the fact that prior art power plants often take a long time to reach steady state after a load change and would sacrifice output efficiency as well.

Embodiments of an ARC-200 SMR power plant as disclosed herein have been provided to satisfy needs of both category of customer. It uniquely provides for load following mode of operation that can comprise a non-safety-grade Balance Of Plant (BOP) and a Brayton cycle energy converter, that may also be suitable for providing optional cogeneration applications for reject heat.

### BRIEF DESCRIPTION OF THE DRAWINGS

The accompanying drawings, which are included to provide a further understanding of the invention and are incorporated in and constitute a part of this specification, illustrate preferred embodiments of the invention and together with the detailed description serve to explain the principles of the invention. In the drawings:

FIG. 1 shows a representation of an Energy Conversion Flow Diagram

FIG. 2 shows a Partial Power Load Map

### DETAILED DESCRIPTION

Embodiments of the present invention can comprise a small modular reactor (SMR) power plant, rated at up to about 200 MWe with about a 10 year whole core refueling interval, along with methods for using such a system. Embodiments can comprise a sodium-cooled, metal-alloy-fueled fast-spectrum nuclear reactor that may drive a Brayton cycle energy converter using supercritical CO2 working fluid. Embodiments of plants may include features that meet the needs of both categories of customer. Embodiments can provide for long periods of time, such as a decade, about 15 years, or about 20 years of energy security at an affordable initial price and at the same time can offer load following capability at a competitive levelized cost of energy (LCOE). Load following can be achieved by adjusting power production outputs determined by fluctuating power demand. Embodiments of the invention, therefore, produce the unexpectedly superior results of offering load following capability at a competitive LCOE and can do this for a long period of time, such as a decade or longer.

Certain embodiments disclosed herein can be referred to as ARC-200 and may offer energy security. This can be achieved by operating fuel at moderate specific power, such as about 25 KWt/Kg of fuel for example, which can extend the (whole core) refueling interval, and in some instances this can be extended to about a decade of base load operation, which interval can be longer for load following operations, such as a decade and a half. Moreover, internal breeding during the operating interval can regenerate the fissile content of the fuel so that at discharge, the fuel contains sufficient fissile material to recycle and fabricate a reload core—this can be achieved by using a makeup of depleted or natural uranium i.e. no enrichment services may be required after the initial core load. In some embodiments such makeup can be achieved by using a makeup of only depleted uranium. In certain embodiments, no enrichment services are required after the initial core load. In some embodiments, five reloads can be conducted over a long period of time, for example a 60 year lifetime of the plant. In some embodiments, the composition of the fuel is not particularly limited, and may take the form as that which is described in U.S. Pat. No. 9,008,259 and U.S. patent application Ser. Nos. 14/680,732 and 15/003,329, each of which are hereby incorporated by reference in their entirety.

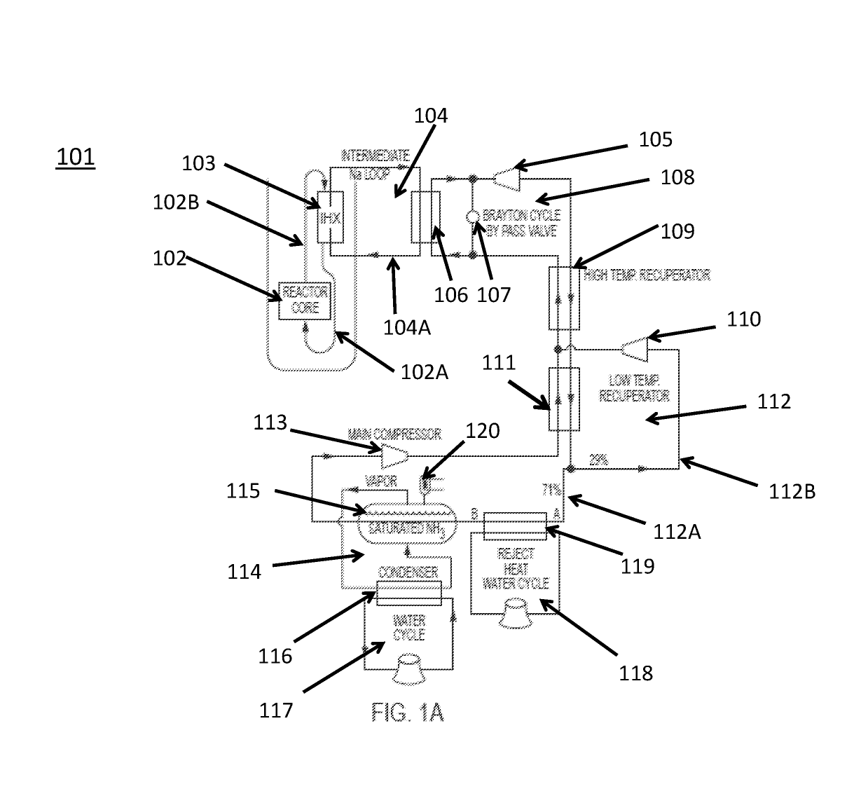

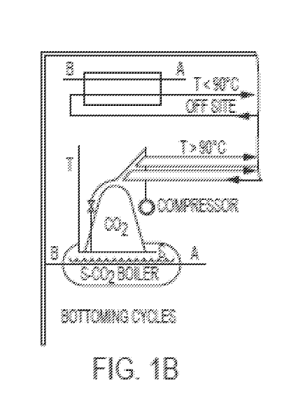

As shown in FIG. 1, certain embodiments of an ARC-200 plant 101 can comprise a reactor core 102. Reactor core 102 can comprise primary sodium portion comprising cool primary sodium flow 102a and heated primary sodium flow 102b. Heated primary sodium flow 102b can enter one or more IHXs 103 where heated primary sodium 102b exchanges heat with secondary sodium flowing through at least one intermediate sodium loop 104. Intermediate sodium loop 104 can comprise secondary sodium flow 104A that can transport heat to energy conversion portion 108 via heat exchanger 106.

Energy conversion portion 108 can comprise a bypass valve 107. Bypass valve 107 can bypass an energy conversion working fluid (such as S-CO2) away from turbine 105 during periods of adjustment as discussed herein.

Embodiments of plant 101 may comprise a turbine 105 that can be a portion of a Brayton cycle energy conversion portion that can be followed by a high temperature recuperator 109 that can provide heat and can be configured to adjust temperature of energy conversion flow material, such as steam or S-CO2. A plant 101 may further comprise a low temperature recuperation portion 112 comprising a low temperature recuperator 111 and a second compressor 110. A low temperature recuperation portion 112 and a high temperature recuperator 109 along with a main compressor 113 and/or a second compressor 110 can operate in conjunction with one another to control and optimize pressure and temperature parameters of an energy conversion working fluid S-CO2 and improve conversion efficiency of the plant 101. Additionally, the high power density aspects of the equipment can operate in conjunction to produce the unexpectedly superior results of achieving significantly improved maneuvering of a time constant for load following as discussed herein.

A portion of the energy conversion material flow can be split into a high flow portion 112A and a low flow portion 112B. A low flow portion 112B can comprise up to about 30% of the flow of energy conversion material and a high flow portion 112A can comprise up to about 70% of the energy conversion material.

High flow portion 112A can be directed to a reject heat exchanger 119 that can use a heat exchange medium 118A such as water to dispose of reject heat and can further cool an energy conversion flow material to a temperature of about 31 degrees C. Such a reject heat exchange medium is not particularly limited and choices for this would be readily envisaged by the skilled artisan. The heat exchange medium 118A can flow through a reject heat cycle 118, where the waste heat exchange can be released, for example as water vapor if water is used as a heat exchange medium. In some embodiments, reject heat cycle 118 may send the flow of heat exchange medium 118A to a bottoming cycle as shown in FIG. 1B, where any waste heat of a heat exchange medium 118A can be used for other purposes as described herein, such as for providing thermal energy to a co-generation application.

A plant 101 may comprise a boiler drum 115 that may comprise boiling saturated ammonia or other industrial material that would be immediately envisaged by the skilled artisan to stabilize the temperature of working fluid as it enters the compressor—holding it constant at a predetermined temperature even as the plant maneuvers during load following operations. A water cycle portion 117 may interact with vapor ammonia via condenser 116 in ammonia cycle 114. Ammonia cycle may also comprise a drum pressurizer 120 to control ammonia temperature in a manner that would be immediately envisaged by the skilled artisan.

The energy conversion material flow may thermally interact with boiler drum 115 to maintain the temperature of a S—CO2 working fluid energy conversion material at a predetermined temperature prior to energy conversion material entering main compressor 113 after which energy conversion material can flow through low temperature recuperator 111 and/or high temperature recuperator 109 and then back to energy conversion portion 108.

Embodiments described herein can comprise systems as described herein along with methods of using such systems. Embodiments can also comprise methods of using such systems for purposes of, for example, generating power, generating cogeneration heat, generating electrical power, providing power using a load following power plant, load following to provide variable power outputs, and/or combinations thereof.

In certain embodiments, a plant can run in load following mode and both a reactor and a

Brayton cycle may undergo frequent maneuvers to partial load as the plant responds to changes in grid demand and/or in grid supply from intermittent sources. Temperature transients arise as the plant adjusts to each new operating point, but these may produce thermal stress loadings on reactor and Brayton cycle equipment. The selected load following strategy can be designed to limit the amplitudes and time constant of load-following-induced temperature transients so as to limit low cycle fatigue degradation of in-vessel structural components. Certain embodiments of the invention thus achieve the unexpectedly superior results of limiting amplitudes of thermal and mechanical stresses that can lead to system failures resulting from load following.

Reject heat removal equipment of the energy conversion cycle can also respond in proportion to the changing electrical power production rate. In the face of changing power, reject heat removed equipment can maintain a Brayton cycle main compressor inlet temperature stationary at its reference value that can be about 31 degrees C. at all partial loads and during the transients as the plant transitions to each new operating state.

Embodiments of the plant can operate in base load. Embodiments of the plant can operate in load following operational mode. Certain embodiments are capable of both base load and load following operational mode.

Certain embodiments of the invention, such as ARC-200, can deliver up to 200 MWe of electricity and simultaneously deliver from its reject heat stream, up to about 300 MWt of heat at about 50-100 deg C., about 80 to 100 deg C., about 90 deg C., and ranges therebetween. Heat supplied from a reject heat stream can be suitable for driving a broad diversity of optional cogeneration applications, such as district heat and water desalination. In some embodiments, the heat can be transported off-site to third-party customers through bottoming cycles as described herein.

Embodiments of the systems' plant's safety aspects can allow for its siting near population centers—where needs for cogeneration missions arise. The embodiments of the invention thus provide the results of being able to provide cogeneration energy, which can be in the form of heat. Plants can be configured such that the entire balance of plant (BOP) zone and all equipment housed there (for example but not limited to, Brayton cycle equipment, switchyard, cooling water supply, heat rejection equipment and any optional bottoming cycles delivering reject heat to cogeneration equipment) can operate without the necessity of supplying any nuclear safety function. Cogeneration aspects using reject heat may have no reactor safety consequence and can be designed, built, and operated to industrial (i.e., not nuclear) standards.

In certain embodiments, Brayton cycle reject heat output changes in response to electrical production rate changes, so the amplitude (but generally not the temperature) of the reject heat supply available for cogeneration missions can rise and fall in proportion to electricity production rate. In some embodiments, reject heat supply may be directly proportional to electricity production rate. For base load operation, when heat output remains constant over long periods such as months at a time, cogeneration processes can independently display time dependences in their heat demands. Brayton cycle heat rejection components of a cogeneration plant can experience transient mismatches between supply of reject heat versus cogeneration demand for heat. For example, a reactor can operate to provide a constant electricity output and also vary outputted cogeneration energy. In some embodiments, a reactor can operate to provide load following electricity output (i.e., providing a variable output) and provide constant outputted cogeneration output. In some embodiments, a reactor's electrical output can provide variable electricity output (i.e., providing a variable output and can also vary outputted cogeneration energy. Advantageously, ARC-200 can buffer transient mismatches between a reactor and a cogeneration portion to provide time for re-alignment of cogeneration system set points—without compromising the requirement to stabilize Brayton cycle compressor inlet conditions. Embodiments can comprise one reactor portion with one cogeneration portion, more than one reactor portion with one cogeneration portion, more than one reactor portion with more than one cogeneration portion, or more than one cogeneration portions with one reactor portion, and may deliver power up to a total of about 500 MWt.

Reject heat from a Brayton cycle can be delivered over a temperature range of 31 degrees C. to about 90 degrees C. and ranges therebetween. Embodiments comprising a bottoming cycle configuration connected to a cogeneration portion can comprise a bottoming cycle configuration that can deliver heat of about greater than or equal 90 degrees C. to off-site cogeneration configurations and a bottoming cycle configuration comprising a heat pump that can deliver greater than about 90 degrees C. heat, and up to about 100 degrees C. in some embodiments, to off-site cogeneration missions.

An ARC-200 power plant can comprise a nuclear island housing a reactor and civil structures and ancillary systems important to safety. In some embodiments, an ARC-200 power plant can be adjacent to a physically-separated balance of plant (BOP) zone that can comprise a Brayton cycle energy converter, switch yard, and reject heat disposition equipment including a cooling water treatment system and forced draft cooling towers.

A nuclear reactor component (for example, 500 MWt) of an ARC-200 plant can be a sodium cooled, metal alloy fueled fast neutron spectrum reactor with a 10 year, whole core refueling interval. When operating such a reactor in load following mode, operating life can be longer than 10 years.

In certain embodiments, a BOP energy converter can be a closed Brayton cycle using supercritical CO2 as working fluid and can deliver up to about 200 MWe of electricity and up to about 300 MWt of reject heat at about 90 degrees C. when at full load.

BOP equipment can receive heat from a reactor, which can be delivered through at least one forced circulation intermediate sodium loop rated at about 250 MWt each. In some embodiments, BOP equipment can receive heat from a reactor, which can be delivered through one or more forced circulation intermediate sodium loops that can sum to about 500 MWt each.

Some plants can comprise passive safety features and can achieve a high level of safety and reliability.

A SMR plant can be constructed from factory-fabricated equipment modules shipped to a site for assembly. In some embodiments, only civil structures are constructed on site. Plants as described herein can have a lifetime of at least 20 years, for example a 60 year lifetime, but the skilled artisan will appreciate that this can be extended by numerous fuel reloads.

Embodiments of plants described herein can load follow over the full range from full power down to near zero power, and can optionally comprise cogeneration portions with its reject heat, for example Brayton cycle reject heat.

BOP portions of embodiments of plants described herein can perform no nuclear safety function and may not have any pathway for equipment malfunction or operator error that occurs in the BOP zone to inject damaging accident initiator events into a nuclear island part of the plant. A BOP portion and equipment housed therein can be classified as non-nuclear safety grade for their construction and operation.

Certain reactors can operate in a fissile self-regenerating mode wherein enough fissile material can be present in a discharged core to fuel a replacement after recycle. Certain embodiments may only require a makeup supply of depleted uranium and may not require enrichment services after an initial loading.

(I) Reactor and Nuclear Island

(A) Reactor Overview

In certain embodiments, a reactor can be a sodium-cooled fast reactor having a heat rating of up to about 500 MWt. It can use less than about 20% enriched uranium fuel of U10Zr metallic alloy composition encapsulated in stainless steel cladded pins. Certain fuel compositions that can be utilized in embodiments of the inventions contained herein are disclosed in U.S. patent application Ser. No. 13/004,974, which is herein incorporated by reference in its entirety. In some embodiments, fuel pins can be clustered (127 pins per assembly) in hexagonal, stainless steel ducts that are arranged in the core in three radial enrichment zones of 10.1, 13.1 and 17.2 enrichment.

In embodiments, a 20 tonne fuel loading is operated at moderate specific power (˜25 Kwt/Kg fuel) reaching an average discharge burnup of 80 MWt-days/Kg fuel after 10 years of full power operation (at CF=0.9). Operating at less than full power, e.g., in reduced or load following mode extends the fuel lifetime to reach the same discharge fuel burnup. Internal breeding can maintain fissile content of fuel nearly constant, and the burnup reactivity swing nearly zero. A discharge core can comprise sufficient fissile mass to recycle and fabricate a reload core—requiring makeup of depleted uranium or natural uranium only (i.e., meaning there may be no need for enrichment services after an initial fuel loading).

A sodium coolant system can operate at ambient pressure in a “pool plant layout” configuration wherein the core and all primary sodium inventory and heat transport equipment can be housed within a primary vessel. The primary vessel can be any material ascertainable to the skilled artisan, such as but not limited to stainless steel, which can be about two inches thick. In some embodiments, a core outlet temperature can be about 500 to about 510 degrees C., about 505 to about 515 degrees C., about 510 degrees C. and ranges therebetween. Certain embodiments may comprise a primary coolant circuit that can operate by forced circulation driven by about up to 4 or more electromagnetic (EM) or mechanical pumps At shutdown decay heat levels, a primary sodium cooling circuit can be driven by natural circulation (i.e., meaning there may be no reliance on an electric power source).

In some embodiments, heat can be transferred from primary sodium into more than one forced circulation intermediate sodium loops through, for example, primary-sodium-to-secondary sodium tube and shell heat exchangers (IHX) each, which may reside inside a reactor vessel. In certain embodiments, secondary sodium remains non-radioactive. Some embodiments may comprise intermediate piping loops that can cross at least one containment boundary and bridge a nuclear island's seismic displacement gap and deliver heat to drive a Brayton cycle in a BOP portion embodiments of a plant as described herein. The heat can be transferred through sodium-to-S—CO2 “printed circuit” type heat exchangers (which may sometimes herein be referred to as HX or IHX, and in general, when referring to heat exchangers these can be abbreviated as HX or IHX) comprised in a BOP portion of a plant.

Redundant passive natural circulation direct reactor cooling system (DRACS) circuits can be immersed in a primary vessel for decay heat removal. Such circuits can operate all the time, transporting heat a medium such as a sodium/potassium (NaK) eutectic coolant using a NaK natural circulation loops that can extend from a primary vessel to NaK-to-air heat exchangers or the like that can be situated in the open atmosphere outside a reactor building.

Certain embodiments may comprise a top deck that can seal a vessel, which can maintain an Ar atmosphere above sodium coolant pool. A deck may support IHXs, primary pumps, DRACS HXs, the control rod drive mechanisms and drivelines and an in-vessel Upper Internal Structure used to stabilize and guide control rod drivelines and thermocouple leads. A deck may comprise a rotating shield plug that can support and position a pantograph in-vessel fuel assembly refueling machine. A deck can provide a port through which fuel assemblies can be removed from a vessel into a cask during refueling operations.

(B) Core

Fuel comprising a core of a reactor can be arranged into clusters of cylindrical cladded fuel pins enclosed in hexagonal ducts called fuel assemblies, as discussed in U.S. patent application Ser. No. 13/004,974, which is herein incorporated by reference in its entirety. In some embodiments, a core can be comprised of 92 fuel assemblies, 6 control assemblies and 2 safety rod assemblies. Given the required overall loading, pins may be of differing diameters and ducted assemblies may contain differing numbers of pins. In certain embodiments, to minimize downtime during whole core refueling, about 92 fuel assemblies that may comprise about 6 control assemblies can be grouped into about fourteen 7-assembly-clusters. Such a configuration can advantageously reduce the number of refueling transfers from about 98 to 14 in the event that whole core refueling is performed. Core assemblies can be surrounded by a row of reflector assemblies, and the reflector assemblies can be surrounded by a row of boron-loaded or other neutron absorbing material shield assemblies.

Shield assemblies can be hexagonal and of a uniform dimension, and can be ducted and hold about 127 fuel pins each. Assemblies can comprise fuel pins all of the same enrichment, but different assemblies can have different enrichments. Fuel can be clad in low-swelling ferritic steel, and each pin can be comprised of an about 60 cm lower shield segment, an about 100 to about 150 cm fuel segment and an upper fission gas plenum segment of about one and a half times the fuel height.

There can be multiple banks with one or more control assemblies. In some embodiments, there are 2 banks of 3 control assemblies each. Some assemblies can comprise an outer duct having a same dimension as fuel assembly ducts and may also comprise an inner movable duct holding neutron-adsorbing pins, which can comprise natural boron or some other neutron absorbing material. Embodiments comprising multiple safety rod assemblies can have safety rod assemblies with identical design.

In some embodiments, to achieve a 10 year or more whole core refueling interval, fuel can be operated at a core-average specific power of about 25 KWt/Kg of fuel and comprise a total core loading of about 20 tonnes of fuel. A fuel charge can, for example, reach an average discharge burnup of about 80 MWt-days/Kg fuel after 10 full-power-years of operation at 0.9 capacity factor.

Internal breeding in fuel assemblies can maintain their fissile content nearly constant over lifetime. Burnup reactivity loss may be essentially zero. Control rods can be withdrawn to ascend from a shutdown state to full power, but thereafter can be banked and moved infrequently, such as only a few times a year, to compensate fuel burnup plus several times per year for reactor shutdown over the reactor's lifetime.

(C) Vessel and Internal Structures

In certain embodiments, a vessel can be about 20 to about 25, about 23 to about 25, about 23 to about 27 feet in diameter (and ranges therebetween) and about 50 to about 55 feet tall, which can be comprised of welded stainless steel plate.

A vessel can house a core and core support structures, permanent shielding, all primary Na coolant, primary system pumps and heat transport equipment, the upper internal structure (as described and referenced to herein) and/or a Redan structure that can partition primary sodium inventory into a hot pool of primary sodium exiting the core and a cold pool of primary sodium exiting the IHXs.

Certain embodiments comprise core support structures that can comprise a core barrel with an internal core former ring that can confine the radial perimeter of the core, and can also comprise a lower coolant plenum. A plenum can receive primary sodium inflow from pumps and distribute the flow to fuel, reflector and shield assemblies that can comprise a top grid plate that confines fuel assemblies that can be at the bottom of the core. A central assembly position may hold a wedge whose downward motion can push the tops of an outer-most-row of assemblies outward and clamp the core against a core former ring, which is illustrated and described in U.S. patent application Ser. No. 14/291,890, which is herein incorporated by reference in its entirety. This wedge can be driven from the deck using, for example a drive rod, allowing unclamping of the core for refueling operations. Permanent shielding can be placed around a perimeter of a core barrel to shield the secondary sodium as it passes through the IHXs. Secondary sodium can remain non-radioactive.

(D) Primary Coolant Flow Paths

Embodiments can comprise one or more primary pumps. Some embodiments comprise one pump, two pumps, three pumps, four pumps, or more. Primary pumps can take their suction from a sodium cold pool and can be used to deliver primary sodium to a coolant inlet plenum through piping. In embodiments having a pool plant layout embodiments, all these aspects can be internal to a vessel. In embodiments having a loop plant layout embodiment, all or some of these aspects can be outside of a vessel.

Some embodiments may comprise pole pieces. Pole pieces can be a bottom fitting on the fuel, reflector, shield and control assemblies. Pole pieces may be situated on the bottom of fuel assemblies and can penetrate holes through a grid plate to receive inlet coolant flow from an inlet coolant plenum. The pole pieces may also house orifice plates that can be used to adjust each assembly's coolant flow rate. Embodiments comprising orifice plates may be used to account for assembly to assembly variations in power, and each assembly's orifice can be dimensioned to produce a more uniform radial distribution in coolant temperature exiting the core into a hot sodium pool. The skilled artisan would readily understood how to dimension such orifices to achieve the ability to produce uniform radial distribution in coolant temperature exiting the core.

Sodium can be heated as it passes through a core and may further be discharged into a hot pool where it can mix and homogenize in temperature. From the hot pool, sodium may enter the shell side of the IHXs where it can be cooled by transferring heat to secondary sodium. Sodium may then discharge into a cold pool. In some embodiments this completes the primary sodium circuit.

Under shutdown conditions, primary coolant flow can be natural circulation driven. After passing through and cooling the core, hot sodium may enter a hot pool, pass through the shell side of the IHXs (without the necessity of any heat removal) and enter a cold pool where it can also enter a heat exchanger such as a DRACS HX, cool, and return to the cold pool. From the cold pool it can flow through any inactive EM or mechanical pumps and into a coolant inlet plenum. From there, sodium can pass through the core—completing a shutdown condition sodium circuit.

(E) Containment

The reactor vessel can sit inside a guard vessel. A guard vessel can serve as a lower portion of containment and additionally can capture primary sodium, should a leak occur in a primary vessel. Annular spacing between vessels can be designed to keep the heat transport path from core to a cooling system such as DRACs intake filled with sodium. This can be used to maintain capability for decay heat removal even in the event of a primary vessel leak. Additionally, continuous natural draft cooling of a guard vessel exterior surface can provide for a diverse backup means (such as a reactor vessel air cooling system (RVACS)) for decay heat removal.

A top portion of containment can be provided by a cover such as a dome that can be a metal dome installed over a top deck on the reactor vessel. The cover can remain in place but can configured to be able to be removed during refueling operations (for example, 5 times over a 60 year plant lifetime). The top portion of containment in some embodiments can be a traditional steel-lined concrete reactor building. Bottom and top segments of containment can fully enclose a primary system that can be positioned inside a sealed, leak proof containment structure.

In embodiments having a pool plant layout, all penetrations through primary system boundaries can be through a top deck. In such embodiments no penetrations are through the vessel and guard vessel walls below a primary sodium free surface. An IHX and pump supports can penetrate the deck through sealed ports. Loops of piping can penetrate a deck. For example, two loops of piping, such as small bore piping penetrate the deck. In embodiments where two pipes penetrate the deck, the two pipes can be configured so that one can be for a side stream to a sodium cleanup system and a second pipe circuit to an Ar covergas cleanup system. Intermediate loop sodium piping can penetrate the deck and other portions as would be understood by the skilled artisan. In some embodiments, intermediate loop sodium piping can cross containment to transport heat to the BOP.

(F) Civil Structures

The vessel and guard vessel can be housed in a below-grade silo, meaning that such a silo can be positioned with a portion below ground level. Vessels and guard vessels can be top-supported and hang from their top flanges in the silo.

A primary system vessel that can comprise a containment structure, along with all ancillary systems important to safety, can be housed in and protected from external hazards by, for example, a thick walled concrete reactor-housing building.

In some embodiments, an entire nuclear island (that may comprise some or all of a silo, reactor, containment structure and/or reactor building) can be positioned on a horizontally seismic isolated basemat. Seismic isolators can support a basemat and can be configured to ameliorate seismic loadings on equipment and structures. Moreover, by transforming site-specific ground accelerations to site-independent basemat accelerations, seismic isolators can enable standardization of reactor and equipment module designs for use at any and all sites.

(VI) S—CO2 Brayton Cycle and BOP

Embodiments of an ARC-200 energy convertor can comprise a closed-loop Brayton cycle using supercritical CO2 as a working fluid. Embodiments of ARC-200 can receive heat input from a reactor through one or more intermediate sodium loops and can dispose reject heat to forced draft cooling towers through a cooling circuit such as a cooling water circuit. Turbine inlet conditions can be in the range of about 470 to about 505 degrees C. (and ranges therebetween) at about 20 Mpa pressure and main compressor inlet conditions can lie just above 31 degrees C. and 7.4 Mpa. A turbine can drive one or more compressors (preferably two compressors in some embodiments, and in some embodiments two compressors, and a generator, achieving a heat-to-electricity conversion ratio of about 40%, or in the range of about 38 to about 44% (and ranges therebetween). Embodiments of Brayton cycles as disclosed herein can be configured to avoid use of a steam generator (SG) which can introduce an incremental safety hazard, should a steam/sodium explosion occur upon a SG tube leak.

FIG. 1 illustrates an embodiment of a closed cycle layout. It may be highly recuperated—separating the recuperation into, for example, two segments that can be configured to account for the strong temperature and pressure dependencies of CO2 properties in the vicinity of the critical point. From turbine exhaust, S—CO2 may pass through a cooling side of a high temperature recuperator first, then through a cooling side of a low temperature recuperator where it emerges at about 90 degrees C., or in the range of about 80 to about 110 degrees C., about 80 to about 100 degrees C., about 85 to about 95 degrees C., and ranges therebetween. Flow can then be split into a high flow portion and a low flow portion. A high flow portion can comprise about 71% of the flow, or about 66 to about 76% of the flow, about 70 to about 75% of the flow, and ranges therebetween. A high flow portion can pass through a heat exchanger, such as a S—CO2-to-water HX that can extract cycle reject heat—which a water stream can carry to a cooling system such as forced draft cooling towers. The high flow portion may then enter a main compressor at about 31 degrees C., which can vary by about +/−½ degree. In some embodiments, the high flow portion can, to attain the benefit of high conversion efficiency, enter at a temperature corresponding to, for example, a temperature of 31 degrees C. that can reduce the work of compression to 20 Mpa. From there, the high flow portion may pass through a heatup side of a low temperature recuperater.

A low flow portion can flow to an intake of a second compressor, which can, in some embodiments, be smaller than a main compressor. In some embodiments, a low flow portion can comprise about 29% of the flow and can flow to the intake of a second compressor and can be compressed to a pressure of about 20 Mpa. The high flow portion and low flow portion can be recombined into a recombined flow stream. A recombined flow stream can pass through a heatup side of a high temperature recuperator where the recombined flow stream can be heated to a reactor inlet coolant temperature of about 324 degrees C. A recombined flow stream may flow to secondary-Na-loop-to-S—CO2 HX that can deliver heat from a reactor that can be configured to take the S—CO2 to a temperature of about 465 to about 505 degrees C., about 470 to about 505 degrees C., about 470 to about 475 degrees C., about 472 degrees C. (and ranges therebetween) and at about 19.9 Mpa at a turbine inlet. The turbine can expand the recombined flow to near the pressure of about 7.7 Mpa, which may complete the circuit.

Heat exchangers and recuperators utilized for the S—CO2 Brayton cycle herein can be “printed circuit” type heat exchangers that may operate at very high power density, for example, as much as a factor of 15 times that of a tube and shell exchanger. Fabricated monoliths can be clustered to achieve required scale.

A Brayton cycle can receive its heat from a reactor and the heat can be transported via one or more intermediate Na loops rated at about 250 MWt each, or corresponding values that sum up to about 500 MWt. Each intermediate loop can comprise one or more in-vessel primary sodium-to-intermediate Na tube and shell heat exchanger, which can comprise loop piping, a sodium pump and/or a sodium dump tank. Heat may be transferred to one or more S—CO2 through Na-to-S—CO2 printed circuit heat exchangers. In some embodiments, BOP equipment may not be placed on a seismic isolated basemat with a reactor and nuclear island. In some embodiments, an intermediate loop piping may comprise a provision to bridge over a seismic displacement gap that can surround a nuclear island.

Embodiments of ARC-200 may produce the superior results of accommodating cogeneration bottoming cycles on account of reject heat that can be delivered over the temperature range of about 90 down to about 31 degrees C., which may deviate as described herein. The high temperature of the Brayton cycle reject heat can allow for a temperature range that can be useful for such missions as hot water district heating, chilled water district cooling, multiple effect distillation of brackish or seawater and for numerous other applications.

Brayton cycle energy conversion can be substituted for other types of energy conversion, for example, Rankine energy conversion although embodiments comprising a cogeneration aspect may comprise turbine steam extraction to attain useful temperatures for reject heat cycles, bottoming cycles, load following, and/or cogeneration aspects as described herein. The skilled artisan would readily envisage how to apply and/or substitute the types of energy conversion to any of the embodiments described herein and would readily understood that a reference to the Brayton cycle herein may also refer to a Rankine cycle and vice versa. The meanings of these terms will be immediately clear to the skilled artisan based upon the context in which they are used herein.

(VII) Nuclear Safety Posture

In some embodiments, an ARC-200 can be positioned on a nuclear island and all or some of the aspects described herein can be housed there and can be designed in accordance with the single failure criterion and the defense in depth principle.

A loss of coolant accident can be precluded by embodiments described herein. An ambient-pressure primary sodium system can be entirely contained in a vessel of a “pool plant layout” that can comprise a backup guard vessel sized to keep the core IHX inlet, and/or DRACS heat exchangers covered even were the vessel to spring a leak.

Decay heat removal can be assured by use of diverse and redundant (DRACS and RVACS) passive heat transport pathways to the ambient air. Passive heat transport pathways can be configured to operate all or a predetermined amount of the time. In some embodiments comprising redundant DRACS plus diverse RVACS, no electrical power supply may be required (neither onsite nor offsite) and no re-alignments of valves nor use of stored coolant inventories may be needed.

The fuel can be contained by multiple layers of containments, for example, doubly or triply contained. Some embodiments of fuel may be contained by its cladding, by a primary vessel (should the cladding fail) and by a containment (should the cladding and vessel both fail).

For whole core accident initiators, a redundant and diverse safety scram system can provide a first line of defense against Design Basis Accidents. A second line of defense based on thermo/structural reactivity feedbacks can provide a backup safety system. Passive response can maintain fuel and coolant temperatures within safe ranges for all Anticipated Transients Without Scram (ATWS) initiators. Passive response can be configured to prevent core damage even should the first line of defense scram system fail to function.

The values of the inherent reactivity feedbacks responsible for passive response can be measured in situ to assure that burnup and ageing effects have not degraded safety performance. A core clamping system can provide a way to tune any feedback parameters and can be configured to avoid anomalous reactivity effects from fuel assembly bowing.

Because coolant (e.g., primary sodium) and fuel are chemically compatible, local faults such as clad weld failure leading to run beyond cladding breach do not propagate into flow blockages and may present no safety issue. Certain embodiments can comprise pole pieces comprising strainers configured to strain primary sodium flow to prevent local blockages by loose parts.

A reactor vessel and a lower containment can be situated in a silo, and all systems can be housed inside a robust shield building that can protects the systems described herein from external hazards, such as natural disasters.

Embodiments of the present system have been modeled and a probabilistic risk assessment (PRA) suggests that the probability of the plant suffering any core damage lies at about less than 10^{∧}-6 per year.

Postulated hypothetical core disruptive accident scenarios (HCDAs) that cause core damage, can avoid super prompt critical power bursts and/or vapor explosions capable of rupturing a primary vessel and challenging containment. The end-state of postulated HCDA events can comprise an intact vessel containing a subcritical, natural-circulation-coolable debris bed of disrupted fuel, but may result in minimal ex-vessel release of radioactivity other than possibly noble gas fission products. Iodine and cesium can be chemically captured by the fuel and coolant and can remain in-vessel.

A PRA will confirm that the probability of core disruption producing offsite dose to the public or environmental damage lies at about less than 10^{∧}-8 per year.

The ARC-200 safety aspects as described herein can assure extremely low probability for off-site dose to the public or damage to the environment and can be expected to allow for power plant siting adjacent to industrial parks located near to population centers. Such positioning allows for the novel and superior results of enabling cogeneration processes as described herein.

(VIII) Non Nuclear Safety Grade Balance of Plant

In some embodiments, a plant site can comprise two zones comprising a nuclear island zone and a balance of plant (BOP) zone. The BOP zone can house an energy conversion portion such as Brayton cycle equipment, a switchyard connection to a power grid, cooling system supply equipment, any forced draft cooling towers, a BOP control room, a maintenance shop, and any plant administration offices.

Decay heat removal may be handled in the nuclear island zone by redundant passive DRACS loops that can comprise diverse backup provided by an RVACS. DRACS and/or RVACS can operate by natural circulation and can dump decay heat into the ambient atmosphere. DRACS and/or RVACS can operate all or nearly all the time and may require no electrical power supply for sensing or for executing valve realignments or driving pumps. No dependence for decay heat removal may be placed on any equipment housed in the BOP zone such as any cooling water supply and/or a switch yard connection to a power grid.

As described by embodiments contained herein, it may not be a necessity for any control system commands to enter a nuclear island zone from a BOP zone. Instead, return temperature and flow rate of any intermediate sodium loops can convey to the reactor all information concerning the heat demanded by the energy conversion portion. Such flow rate and temperature signals can be bounded above and below by physical phenomena readily ascertainable by the skilled artisan and for all signals so bounded and transmitted into the nuclear island zone via any intermediate loop, the reactor can respond within a domain of safe power level and safe temperature and can be configured to match the reactor's heat production rate to that heat removed through any intermediate sodium loop. Some embodiments can be configured so that such bounding can occur even as intermediate sodium flow moves to a bound (eg zero flow), and even if the reactor's SCRAM system should fail to actuate.

Provisions for Passive Load Following

### Load Following Approach

Certain embodiments as described herein can operate at any power output from about zero up to about 100% (of about 200 MWe). Certain embodiments may operate while keeping the highest and lowest fluid temperatures of the plant (e.g., the core coolant outlet/turbine inlet temperature and the Brayton cycle compressor inlet temperature, respectively) stationary at their full power reference values for all levels of partial load. This can produce the surprising and unexpected results of retaining high energy conversion efficiency at partial load and maintaining a reactor coolant outlet temperature having a large margin to damage at all partial-load operating states.

Embodiments described herein are well-suited for load following operation. The Brayton cycle equipment, for example, may be preferred because it is nimble and of small equipment count. Its output can be via a few variable adjustments.

On the reactor side, the reactivity change between output power levels can be small, such that large motions of control rod banks are not required to change power output. In some embodiments, reactivity changes can be small enough (e.g., on the order of a few tens of cents) to be handled by thermo-structural reactivity feedbacks such as core radial expansion driven by a few tens of degrees C. of coolant heatup. Small reactivity control requirements for ARC-200 are a benefit as a result of the comparatively high value of thermal conductivity of metal alloy fuel—which can vastly diminish (as compared with oxide fuel) the fuel temperature dependence on its power density, and the associated swings in Doppler reactivity feedback that result from changes in power level.

Unlike thermal neutron spectrum reactors, time dependant Xenon reactivity feedback is negligible in ARC-200's fast spectrum, as described by embodiments herein.

The high value of thermal conductivity and the ductility of metallic fuel can easily accommodate thermal transients associated with load following operations. On the other hand, the high value of film coefficient of heat transfer between sodium coolant and steel in-vessel structures means that, both amplitude and time constant of primary coolant temperature changes may be constrained to limit thermal stress loads on in-vessel structures. Unlike loop plant layouts, ARC-200's pool layout provides significant thermal inertia to superiorly buffer coolant temperature transients.

Some embodiments keep all nuclear safety related equipment and operations confined within a nuclear island zone of the plant, and embodiments of the ARC-200 load following control can be executed passively. In some embodiments, load following control can be executed by moving control rods under active command of a plant control system that jointly controls both reactor and Brayton cycle energy converter.

In embodiments using a passive load following scheme, the Brayton cycle can be controlled actively in response to dispatch requests from a grid operator—drawing the heat it needs from any intermediate Na loops and embodiments of the reactor can also respond passively to bring its heat production into balance with the heat being removed through any intermediate Na loops.

(A)—Active Control of the S—CO2 Brayton Cycle Power Output

An energy conversion cycle, for example a Brayton cycle, can be actively controlled. In embodiments comprising a load following portion, the flow rate of S—CO2 working fluid can be the principal power output control variable, whereas the temperature and pressure set points around the cycle remain essentially invariant vs load. For example, some embodiments may comprise S—CO2 inventory storage tanks that can provide for shunting S—CO2 inventory in and out of a closed Brayton cycle loop, thus controlling working fluid mass flow rate circulating through the cycle.

Some embodiments may comprise a turbine bypass control portion. S—CO2 inventory adjustments take time to complete, and embodiments can comprise a turbine bypass control to facilitate power changes that are faster than the time constant of inventory adjustment. A turbine bypass control may not dump heat to any reject heat disposition system. In some embodiments, a turbine bypass control can bypass the entire Brayton cycle and return S—CO2 exiting the intermediate Na-to-S—CO2 HX back to the entrance of that HX.

In some embodiments, a reduction of electricity production rate can cause the temperature of Na returning to the reactor through the intermediate Na loops to increase. The reject heat disposition system may not be required to handle more than about 300 MWt, and can be configured to handle up to about 300 MWt. During energy output conversions, on the way to the new power level, any excess of heat production that is not converted to electricity may be stored in the plant by heatup of the primary sodium coolant inventory in the reactor.

(B)—Passive Load Following by the Reactor

In an embodiment, a system may comprise reactor passive load following wherein a reactor can respond to BOP heat demand on the basis of innate reactivity feedbacks with control rods remaining fixed. In some embodiments, a reactor can be configured to passively seek (for example, through the action of reactivity feedbacks) to maintain the reactor's heat production rate in balance with any heat being removed through any intermediate Na loops. There may be no necessity for any direct control signals from a grid operator, nor from a Brayton cycle control room to the reactor control system. A grid operator can communicate a change in electricity production rate to a Brayton cycle energy convertor control room operator. The Brayton cycle S—CO2 inventory and flow rate can be adjusted to modify the Brayton cycle temperature and pressure set points as required to take the Brayton cycle to its new power output. In an embodiment, it may not be necessary for any electronic control system to send automatic control rod adjustment commands to the reactor. In certain embodiments, during load following, control rods may not move. In such embodiments, temperature control and/or load following may be accomplished by configuring the Brayton cycle so it extracts a predetermined amount of heat from any intermediate sodium loops, and the reactor can be configured so that the reactor may passively self-adjust its heat production rate to match the heat removal rate through the sodium intermediate loops to the BOP.

(C) Communicating the BOP Demand for Heat Through Intermediate Na Loops

Some of embodiments of plants described herein may comprise at least one intermediate sodium loop. In embodiments with more than one intermediate sodium loop, each intermediate sodium loops may be running at different power levels and each may undergo different and independent process adjustments, such as flow, temperature control, pressure control, and the like. Some embodiments as described herein can mix a primary sodium hot pool and/or a sodium cold pools that can provide for integration of BOP heat demand signals.

Primary sodium can be wholly contained in a vessel. Primary sodium can comprise a well-mixed hot pool and a well-mixed cold pool. These pools can be separated by any suitable barrier, such as for example, a redan. In embodiments with more than one intermediate sodium loop and IHX, each primary sodium flow that enters the cold pool (e.g., after passing through a different IHX) can have different temperatures if each intermediate sodium flow rate and/or return temperature differ from one loop to the other. Mixing in the cold pool can homogenize the cold pool temperature so that, even in embodiments with more than one pump, each pump taking their suction from the cold pool can discharge uniform-temperature primary sodium into the core coolant inlet plenum. Primary sodium flow may enter the core with a primary sodium core inlet temperature that reflects the integral of heat extraction from the intermediate sodium loops. Reactor power can be configured to respond to any change in primary sodium core inlet temperature on the basis of reactivity feedbacks introduced by, for example, grid plate radial thermal expansion driven by the deviation of a primary coolant inlet temperature from the reference coolant inlet temperature.

Heated primary sodium can exit fuel assemblies at a range of flow rates and temperatures into a hot pool where the heated primary sodium can mix to achieve a uniform mixed mean heated primary sodium core outlet temperature. Heated primary sodium can then enter at least one (for example, two) IHX where it can transfer heat to an intermediate sodium loop. Some embodiments comprising more than one intermediate sodium loop can comprise secondary sodium and the secondary sodium in each of the intermediate sodium loops can exit an IHX at the same hot pool mixed mean core outlet temperature. Secondary sodium temperatures exiting the IHXs can all have the same temperature which can be between about 5 and about 10 degrees C. below the heated primary sodium core outlet temperature. In some embodiments comprising more than one intermediate sodium loop, each heated intermediate sodium flow can have the same IHX outlet temperature even if their flow rates are different. In some embodiments, the secondary sodium inlet temperature to the S—CO2 turbine can be thereby maintained only slightly below the heated primary sodium core outlet temperature (i.e., about 5 to 10 degree C. below).

(X) Reactor Power Control Via Innate Reactivity Feedbacks

(A) Reactor Startup and Establishing the Full-Power Reference State Point

Reactors as disclosed herein can be brought from hot-standby/zero power-up to full power and full flow at reference coolant inlet temperature and reference outlet temperature by withdrawing control rods. Withdrawing control rods may overcome the negative reactivity feedback resulting from the reactor's negative power coefficient of reactivity. The total reactivity to be overcome by rod withdrawal when rising from an isothermal reactor at reference coolant inlet temperature to full power/full flow can be denoted by a reactivity parameter, (A+B), which can be measured in cents of negative reactivity. Feedback parameter, A, specifies a reactivity loss associated with average fuel temperature rise above coolant average temperature. Parameter B can specify the reactivity loss due to rise in average coolant temperature above coolant inlet temperature. Parameter, C, can be characterized as an inlet coolant temperature reactivity coefficient that is applied to inlet temperature deviations relative to reference coolant inlet temperature at full power condition. All are negative feedbacks and all are measurable in situ. For ARC-200 their values are about −0.035 cents, about −0.273 cents and about −0.0025 cents/deg C. respectively for A, B and C. Negative feedback values can vary according to specific core design and vs fuel exposure, but, generally, the skilled artisan will recognize to keep A, B and C negative with B/A>>1. The embodiments as described herein are capable of achieving these unexpected and superior results as a result of the configurations and benefits described herein.

After rod withdrawal has overcome the reactivity, (A+B), a reactor can be configured so that it sits stationary at a zero reactivity steady state, full power, and full flow condition, so long as the temperature distribution in coolant, core and core support structures attained at the full power/steady state remain constant. At this point, the control rods can be banked and thereafter may not be used to adjust power output.

After rod withdrawal, embodiments of the reactor as described herein can operate autonomously wherein the asymptotic response of the core power level after any changes of primary sodium flow rate and/or primary sodium inlet temperature (changes which cause reactivity to depart from zero) can bring the reactivity back to zero. This autonomous behavior can be modeled by a quasi static reactivity balance that requires zero reactivity at the asymptotic power attained following any new conditions of flow and primary sodium inlet temperature.

0=A(P−1)+B(P/F−1)+C(delta T cold pool) (1)

Here, P and F are power and flow normalized to those full power and full flow conditions that prevailed for the zero-reactivity temperature distributions in fuel and primary sodium at the reference full power state point. This relationship among independent variables, e.g. F and delta T cold pool, and dependant variable, P, can be combined with the reactor primary sodium temperature rise relationship,

T-out=T-in-reference+delta Tcold pool+(P/F)×(Core delta T-reference)

where,

T-out-reference=510 deg C.

T-in-reference=355 deg C.

(Core delta T-reference)=155 deg C.

to contrive independent variable combinations which achieve zero reactivity and at the same time retain the reference value for T-out even as dependant variable, P, varies over a range zero to 1.

(B) Simple Passive Approach for Base Load Operation

As an example of an approach for passive reactor load follow, in the event a plant is operating at full power, a grid operator adjusts the system for a decrease to half of full power electricity delivery to the grid. A BOP operator can then actively adjusts the parameters of the Brayton cycle energy converter equipment to extract only half as much heat from the intermediate Na loops—which can be configured to be optimally sufficient to produce the reduced-by-half electricity delivery rate to the grid. With less heat extracted from intermediate Na in an intermediate Na loop, the return temperature (e.g., secondary sodium IHX outlet temperature) in the intermediate Na loop (that can be at fixed flow rate) can increase—this can cause the temperature of primary Na exiting from at least one IHX into a cold pool to increase. Heated primary Na can then be pumped into a reactor core and operating on a reactivity feedback coefficient, C, can create a negative reactivity that can causes reactor power to start decreasing. The reactor can undergo a slow transient to reach a new equilibrium state having zero or approximately zero reactivity when the reactor's heat production matches the heat removed through the intermediate Na loop. Such capability, results, and controllability are superior and unexpected results achieved by various embodiments as disclosed herein. A final equilibrium state can be that for which an intermediate Na loop flow rate, primary pump speed, and control rods have all remained fixed at their full power values while a cold pool temperature can be adjusted upward and the primary sodium temperature rise across the reactor core can be adjusted downward.

By inserting the new asymptotic power level, P=½, and the new asymptotic P/F=½ ratio into the quasi static reactivity balance equation

0=A(P−1)+B(P/F−1)+C(delta T cold pool)

and using examples of ARC-200 feedback parameter values for A, B and C of about −0.035 cents, about −0.273 cents and about −0.0025 cents/deg C., respectively partial load state point properties can be found.

For this example, the quasi static reactivity balance shows that the reactor's power production will balance the BOP demand when the cold pool temperature has risen by 61.6 degrees C.

(delta cold pool T)=(A+B)/2C=61.6 deg C.

The resulting core outlet temperature is

T-out=355+61.6+(½)×(155)=494 deg C.

The cold pool heat capacity can be about 3.2 degrees C./full power second so it would take about 19.25 full power seconds of incremental energy deposited into the cold pool to heat it up enough to bring reactivity back to zero.

If the cold pool is assumed to be adiabatic, the heatup time interval would take approximately 38.5 seconds at the new power level.

(500/2)×(delta t)=38.5×(500)

Repeating these steps for the example of a reduction down to ¾ of full power shows for that case

(delta T-cold pool)=30.8 deg C.
Cold pool energy absorption=9.6 full power seconds
Adiabatic cold pool heatup time=12.8 sec
T-out drops from 510 down to 502 deg C.

These two examples illustrate passive load follow for a fixed control rod position and fixed primary and secondary pump (i.e. wherein secondary pumps can pump secondary sodium) speed strategy, wherein (given fixed intermediate Na loop flows), loop return temperature (i.e., secondary sodium exiting an HX for an intermediate Na loop and an energy conversion portion) can convey information (i.e, other process parameters can self adjust in response to reactivity feedbacks) regarding the integrated heat demand from the BOP. In some embodiments, when cold pool temperature rises, the temperature rise across the core decreases. Some embodiments can be fully passive, which may be suitable for base load operation where changes in power output are infrequent and small.

(C) Passive Approach for Load Following Operations—Reducing Thermal Stresses

A Brayton cycle partial load strategy may be based on maintaining temperature and pressure set points around energy conversion loop portion relatively unchanged by adjusting S—CO2 flow rates in proportion to changing power demands. In some embodiments, a reactor primary sodium flow rate can be adjusted in proportion to changing power demand to maintain a constant P/F ratio.

In some embodiments, a Brayton cycle operator can signal reduced heat demand by reducing flow rates in an intermediate sodium loop while return temperature may remain relatively constant.

Heat removal by each intermediate sodium loop can be measured using safety-grade flow meters and thermocouples located in the nuclear zone. A nuclear zone can comprise a nuclear island, which can comprise a whole plant site excluding the BOP. All nuclear safety grade equipment and structures can reside in the nuclear island. By determining a new BOP heat demand, a primary pump speed can be adjusted downward (or upward) to maintain P/F ratio constant while holding control rod position fixed. Some embodiments can hold coolant temperature rise across the reactor core constant. For the example of a power adjustment to ½ power as described above, primary pumps can be adjusted to ½ of full power flow. The quasi static reactivity balance gives

(delta cold pool T)=A/2C=7 Degree C.

Primary sodium temperature can rise uniformly everywhere in the core by about 7 degree C.—(to overcome the reactivity, A(½−1)=0.035/2 cents that is introduced when the temperature rise in the fuel pins drops and introduces positive Doppler feedback). Some embodiments produce minimal temperature field changes.

As compared to inlet temperature passive control, an embodiment that adjusts primary pump speed for load following can dramatically reduce temperature swings on in-vessel structural components, and in-vessel structures can thus be exposed to lesser thermal stress when power demand changes. Embodiments described herein are able to achieve these unexpected and superior results, which is highly beneficial because load following operations may require frequent power adjustments.

Safety grade sensing of intermediate sodium loop conditions can be performed to in the nuclear zone at the entrances to intermediate sodium loop IHXs as well as adjustments of primary pump speed.

Intermediate sodium loop flow rates can be actively adjusted by a Brayton cycle operator in the non-nuclear safety grade BOP zone.

Pump speed control can introduce an incremental accident initiator opportunity. If a sensor malfunction leads to spurious primary pump speed commands or should intermediate sodium loop flow rates be adjusted incorrectly, these parameters can be adjusted in the non-nuclear safety grade BOP zone. In certain embodiments, the reactor's passive safety response to any and all physically attainable primary pump conditions and/or to any and all physically achievable intermediate sodium loop conditions can maintains the reactor in a safe state, even if a scram system fails.

(XI) Maintain Core Outlet Temperature and Turbine Inlet Temperature Stationary at all Values of Partial Load

In the interest of retaining the large safety margins of the full power state and the high value for Brayton cycle conversion efficiency attained at the full power operating conditions, the reference (full power/full flow) values for mixed mean core outlet temperature and for turbine inlet temperature can be maintained as near as possible to their reference, full power values at all or nearly all partial load conditions.

As described herein, passive load follow examples allow core outlet temperature to change as a function of partial load, but a combination of inlet temperature and pump speed passive load follow can be used to create a partial power load map for passive load follow which maintains core outlet temperature at its reference full power value for all partial loads.

(A) Partial Power Load Map Example

Equations (1) and (2) can be re-arranged under the constraint that T-out=T-out, ref to the forms

(delta T-cold pool)=(Core delta T-reference)×(1−P/F)

P=1+[B−C(Core delta T-reference)]×(1−P/F)/A

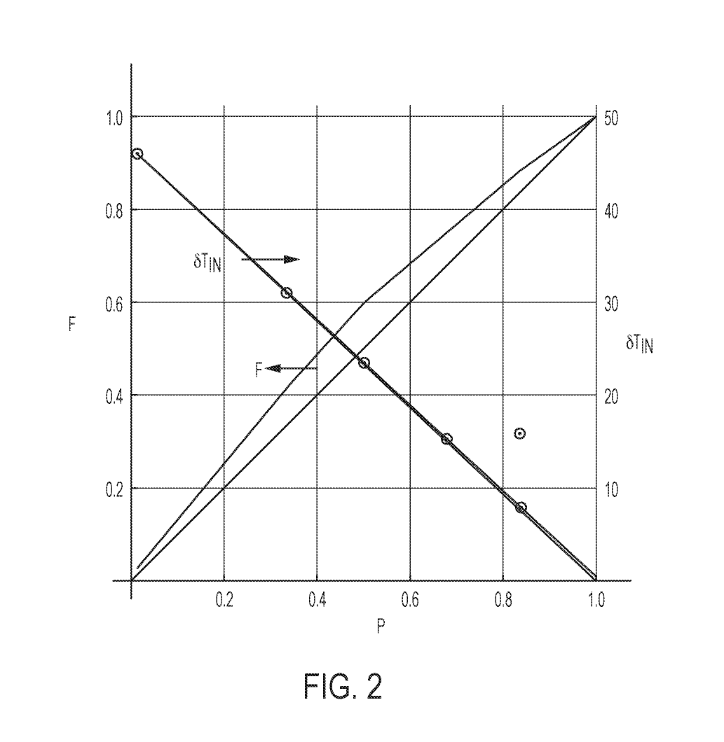

By repeatedly selecting a value for P/F, then solving for (delta T-cold pool) and for P, a partial power load map enumerated in the table and illustrated in FIG. 2 can be generated where for every power level from full power down to zero (on the abscissa) is shown a primary flow rate and a change in cold pool temperature that can produce zero reactivity at a corresponding power level.

TABLE 1

| P/F | P | F | Delta T cold pool | delta t (sec) |
|---|---|---|---|---|
| 1.0 | 1.00 | 1.00 | 0.00 | — |
| 0.95 | 0.84 | 0.95 | 7.75 | 2.9 |
| 0.90 | 0.67 | 0.75 | 15.5 | 7.2 |
| 0.85 | 0.51 | 0.60 | 23.3 | 14.5 |
| 0.80 | 0.35 | 0.43 | 31.0 | 27.7 |
| 0.70 | 0.02 | 0.03 | 46.5 | 725.0 |

As power is reduced, primary flow can be reduced so that core delta T decreases as shown in Table 1. This can be compensated for by raising the cold pool temperature enough to produce an unchanging heated sodium core outlet temperature. The new core average primary sodium temperature can end up a little higher than the reference case. Primary sodium temperature can be raised enough to overcome positive Doppler reactivity, A(P−1), that can be introduced when reducing fuel pin power density.

In certain embodiments, when a Brayton cycle operator receives a request, for example, to reduce power to ½ full power, the operator can adjust S—CO2 mass flow rate by half, and also reduce intermediate Na mass flow rate by half. The signal that BOP heat extraction from the intermediate sodium loop has changed can travel through the intermediate sodium loop quickly (e.g., within seconds) and be measured inside the nuclear safety zone where the primary flow rate will be reduced by about half, according to the partial power load map of Table 1 or plot shown in FIG. 2. Then, over a period of time, for example several minutes, a cold pool temperature will rise, all system temperatures will stabilize and the new steady state will establish itself at half power with T-out of the intermediate sodium loop at its reference full power value.

(B) Approximate Response Time

Response time (i.e., the time it takes for the overall plant to reach the new equilibrium state where all transients have died away) can be set by the reactor because relative to the reactor, an energy conversion portion such as a Brayton cycle has less thermal inertia. In embodiments, response time may not be set by an energy conversion portion. A reactor may adjust slowly, over multiple minutes depending on the size of the change in power demand, which may be a result of large heat capacities and to the presence of delayed neutron precursors. Delayed neutron precursor isotopes have half lives of several minutes and new precursors can be created during the transient to a new equilibrium state. Sodium primary pump flow rate reduction time constant can be made to approximately match the rate of decay of delay neutron precursors, to ameliorate power-to-flow mismatches that could lead to core outlet temperature overshoots. Temperature fields in in-vessel core support structures respond to changes in primary sodium temperatures over time intervals that may be multi-minute time intervals. Cold pool temperature change may be required by a partial power load map and may require several tens of seconds of incremental heat deposition to accomplish.

Delta T of Table 1 shows the time required to heat up a cold pool, at a new power level vs full power level. Some embodiments of adjustments may comprise a step change from full power to the new power and assume an adiabatic cold pool.

The large thermal mass of a primary sodium pool can slow the approach to thermal equilibrium at the changed power level. Certain embodiments described herein will complete a step change in about 500 seconds after starting, but require another 500 seconds to reach a final steady state.

(C) Monitoring and Adjusting for Drifts of Feedback Parameters with Aging

Over time, reactivity feedback parameters e.g., A, B and C, can change slightly as the fuel burns, as power profile shifts and as any in-vessel structures suffer creep deformations.

The values of reactivity feedback parameters, A, B and C, can be measured non-intrusively in situ by instruments to monitor their drift and to assure that they remain within Technical Specification range. A partial power load map can be periodically updated using the most recent measurements of A, B and C.

In some embodiments, a fuel assembly clamping wedge can make fine adjustments in the values of B and C if needed.

(XII) Stabilizing Compressor Inlet Temperature

Without being bound by theory, the superior high conversion efficiency of a S—CO2 Brayton cycle is believed to derive, in part, from compressing the S—CO2 working fluid at a temperature very close to and just above a predetermined temperature, such as 31 degrees C. plus or minus ½ degrees C., and more particularly a temperature of 30.98 degrees C.

For embodiments operating within base load operations, where the plant remains at full power conditions for long periods, S—CO2 temperature at the energy conversion compressor intake can be controlled by means of adjustments of the water flow rate through a S—CO2-to-water reject heat exchanger.

For embodiments operating within load following operations, a plant operating state can change frequently, and transient S—CO2 flow rate and temperature may occur each time a transition to a new operating state is made. Even in the face of such set-point changes and transients, the conditions at a main compressor entrance can be made to remain stationary at about 31 degrees C. to a high degree of accuracy.

An isothermal boiling approach can be used in certain embodiments of an ARC-200 to hold S—CO2 temperature at an entrance to a main compressor at about 31 degrees C. Prior to entering a main compressor, a Brayton cycle's S—CO2 working fluid can pass through tubes immersed in a liquid pool region of a heat exchanger drum that can be partially or almost entirely filled with a pool of boiling ammonia (or some other industrial compound of appropriate thermodynamic properties that can be maintained at a temperature of about 31 degrees C. by controlling a boiling drum pressure). The Brayton cycle S—CO2 flow can exit tubes running through the boiling drum at about 31 degrees C. Embodiments can be configured so that a Brayton cycle S—CO2 temperature exits a boiling drum at a temperature independent of its flow rate and independent of its temperature upon entering the boiling drum.

Any ammonia vapor released from a boiling pool can accumulate above a pool in a shell-side of the boiling drum and can be transported to and condensed in an ammonia-to-water heat exchanger and then pumped back into the pool inside the boiling drum. The water can carry any reject heat to forced draft cooling towers.

A S—CO2-to-water reject heat HX that can be in series with a drum that can be sized to handle a load of up to about 300 MWt, so that a boiling drum system can handle any transient mismatches, meaning that the boiling drum need not be large. An inventory of liquid ammonia in a boiling drum's boiling pool can be appropriately sized by the skilled artisan to provide heat capacity sufficient to absorb several full power seconds of reject heat—enough to provide time to realign a reject heat system (which may comprise valves and equipment) for a new operating point of a Brayton cycle.

Certain embodiments comprising a reject heat system may be useful for cogeneration missions as well.

Provisions to be “Cogeneration-Ready”

(XIV) Overcoming Historical Barriers to Cogeneration

At full power, an ARC-200 power plant can produce up to about 200 MWe of electricity along with up to about 300 MWt of reject heat. This reject heat can be used for productive activities such as district heating and/or water desalination although other uses will be immediately envisaged by the skilled artisan. Prior art reactors were unable to achieve this result and the skilled artisan would not have expected such an outcome.

In some embodiments, cogeneration heat can be transported via hot fluid flows in pipes for up to several miles without significant loss.

(C) Overcoming Technical Issues

(1) Backup Disposition of Reject Heat

Some embodiments of the plant can comprise a cogeneration portion using energy conversion material thermal energy that can be delivered through a heat exchanger (FIG. 1, 119 for example). Cogeneration equipment may not be online all the time, or may be consuming only a predetermined and controllable fraction of reject heat. Therefore, a power plant reject heat system sized for full power operations may be required.

(2) Buffering Transient Miss-Matches Between Supply of Heat Vs Demand

An energy conversion cycle, preferably a Brayton cycle reject heat output adjusts up and down in response to changes of electrical production rate, so the instant-to-instant amplitude (but not necessarily the temperature) of the reject heat supply made available for cogeneration missions can vary in proportionally to plant electricity production rate.

Under base load operation, reject heat supply can remain constant for long intervals of time, such as months at a time. Cogeneration processes can be expected to independently display time dependences in their heat demands, meaning that cogeneration aspects may not need to continuously operate. Should the SMR be operated as both a cogeneration plant and a load following plant, then heat supply and demand can both be changing repeatedly.

A power plant reject heat system can experience transient mismatches of production of heat versus demand for heat, and third party cogenerating operators may be responsible to adjust their usage to what is available—which may take time. A plant owner may be responsible to provide a window of time for the adjustment to be made.

Embodiments as described herein can “buffer” such transient mismatches. In embodiments comprising a boiling drum, the thermal mass of the isothermal boiling drum 115 as displayed in FIG. 1 can be configured to have sufficient thermal mass to provide time for re-alignment of cogeneration system set points when heat supply versus demand becomes misaligned.

Features of the ARC-200 plant and its various embodiments as described herein overcome historical barriers to cogeneration and make provisions to utilize reject heat for productive purposes in cogeneration applications, ARC-200 can be delivered “cogeneration-ready”, giving the customer the option to sell heat if it makes business sense to do so.

(XV) A Bottoming Cycle to Supply Applications Requiring Heat of <=90 Deg C. and >31 Deg C.

(1) Bottoming Cycle Energy Carrier

Bottoming cycle heat transport loops can transport some or all reject heat. Such reject heat can be drawn from reject heat disposal equipment in the power plant's non-nuclear safety grade BOP, for example reject heat cycle 118 as shown in FIG. 1, and can carry it across plant site boundaries to where the heat is to be used.

An example of a S—CO2 Brayton cycle's reject heat maximum temperature of 90 degrees C. is below the water boiling point, and ambient pressure water can be used for any off-site energy carrier (rather than CO2)—because it can have a much higher volumetric heat capacity, which can avoid pressurized piping and also to avoid introducing an asphyxiation hazard at offsite locations.

(2) Bottoming Cycle Configuration

Certain embodiments can comprise a bottoming cycle portion as shown in FIG. 1B that can be a re-circulating closed loop or, if a reliable water source is available for make-up, it could be an open cycle or a combination thereof.

A bottoming cycle configuration is shown in the top illustration of FIG. 1B can be applicable when the cogeneration application requires heat of less than about 90 degrees C. and greater than about 31 degrees C. Such applications can include, but are not limited to, hot water district heating, multi-effects distillation of brackish or sea water and agriculture and aquiculture applications.

Some configurations can be a closed loop bottoming cycle that can receive heat through a heat exchanger such as a S—CO2-to-ambient pressure water HX 119 that can be positioned after an energy conversion portion 108, such as a Brayton cycle, at a low temperature recuperator exit. A bottoming cycle loop as shown in the top illustration in FIG. 1B can transport heat off site to multiple applications and can return to the power plant at a temperature greater than about 31 degrees C. where it can be re-heated in a HX. S—CO2 exiting the HX can enter the tube side of a boiling drum 115 where the S—CO2 temperature can be stabilized to about 31 degrees C. After exiting the boiling drum 115, S—CO2 can enter a main compressor 113, having a temperature of about 31 degrees C. at the S—CO2 enters the main compressor 113.

Any residual reject heat remaining in the S—CO2 after it leaves the HX supplying a bottoming cycle may end up deposited in to the atmosphere through a water cycle 117, where water cycle can condense any ammonia that accumulates on the shell side of the boiling drum—that can cause incremental vapor generation. This heat can be transferred by condensation, through a HX to the closed loop water cycle 117 that can loop to forced draft cooling towers. This pathway may be sized to take up to about 300 MWt of reject heat load for when cogeneration heat demand is zero.

(XVI) Configurations for Applications Requiring Heat of >90 Deg C. and/or <31 Deg C.

When a cogeneration application requires a temperature in excess of about 90 degrees C. or greater than about 31 degrees C., a heat pump or refrigeration cycle can be used. In some embodiments, dedicated and localized heat pumps or refrigeration cycles operating off a less than about 90 degrees C. bottoming cycle loop can be installed as disclosed herein. Each cogeneration customer may draw heat and electricity from off-site grids of utility electricity and utility heat, and could optionally dump whatever waste heat he generates back into the bottoming cycle circuit.

In some embodiments, an ARC-200 plant can comprise a large-scale, on-site, reverse Rankine cycle, mechanically-compressed heat pump utilizing CO2 as working fluid, which could be used to supply a cogeneration heat source of greater than about 90 degrees C. For example, the bottom illustration in FIG. 1B illustrates a large-scale, on-site heat pump configuration that can use CO2 as a working fluid and mechanical compression.

A large-scale heat pump configuration can emplace a heat pump apparatus in a non nuclear safety grade BOP zone of the power plant site and deliver heat to off-site customers through closed loop bottoming cycles loop piping. The choice of energy carrier (such as pressurized steam) may depend on the cogeneration mission. As illustrated by FIG. 1B, provisions could be made for multiple bottoming cycles, receiving heat from the high-temperature/high-pressure segment of a CO2 heat pump cycle, to carry heat of differing temperatures to multiple off site customers.

The cumulative usage might not sum to up to about 300 MWt, but a backup reject heat disposition apparatus could be the same as for the less than about 90 degrees C. configuration, but some configurations may account for variations by enlarging the backup reject heat disposition apparatus to accommodate any heat energy injected by the mechanical compressor of the heat pump.

As demonstrated by embodiments of systems and methods described herein, it is to be appreciated that the skilled artisan would have readily understood how to apply aspects of processes described herein to systems and vice versa.

As used herein, the terms “reactor”, “plant”, “ARC-200”, and “small modular reactor (SMR)” may refer to an entire system of embodiments as described herein or portions of embodiments as described herein. These terms may also be used interchangeably and their meaning will be immediately ascertainable to the skilled artisan based on the context in which they are used in the disclosure and claims.

As used herein, the terms “coolant”, “core coolant”, and “primary sodium” may be used interchangeably and their meaning will be immediately ascertainable to the skilled artisan based on the context in which they are used in the disclosure and claims.

As used herein, the terms “intermediate sodium” and “secondary sodium” may be used interchangeably and their meaning will be immediately ascertainable to the skilled artisan based on the context in which they are used in the disclosure and claims.

As used herein, the term “flow rate” will generally refer to the mass flow rate unless specifically stated otherwise. Additionally, percentages that refer to flow rates will generally be based on a percent by mass basis unless specifically stated otherwise.

IHXs and HXs may refer to heat exchangers generally or shell and tube heat exchangers. The skilled artisan will be able to understand the meaning of such term depending upon the context in which it is presented.

Although the foregoing description is directed to the preferred embodiments of the invention, it is noted that other variations and modifications will be apparent to those skilled in the art, and may be made without departing from the spirit or scope of the invention. Moreover, features described in connection with one embodiment of the invention may be used in conjunction with other embodiments, even if not explicitly stated herein.

1. A small modular nuclear reactor plant comprising a reactor core; wherein the reactor core comprises
a primary sodium portion comprising:
a cool primary sodium flow; and heated primary sodium flow;
and wherein the heated primary sodium flow enters one or more heat exchangers and the heated primary sodium exchanges heat with secondary sodium flowing through at least one intermediate sodium loop.

2. The small modular nuclear reactor of claim 1, wherein the intermediate sodium loop comprises secondary sodium flow that transports heat to energy an conversion portion via the one or more heat exchangers.

3. The small modular nuclear reactor of claim 1, wherein the small modular nuclear reactor further comprises a turbine that operates as a portion of a Brayton cycle energy conversion portion.

4. The small modular nuclear reactor of claim 3, wherein the Brayton cycle energy conversion portion further comprises a high temperature recuperator configured to provide heat to an energy conversion flow material.

5. The small modular nuclear reactor of claim 4, wherein the high temperature recuperator is further configured to adjust temperature of the energy conversion flow material.

6. The small modular nuclear reactor of claim 5 wherein the energy conversion flow material is selected from the group consisting of steam or supercritical CO2.

7. The small modular nuclear reactor of claim 4, further comprising a low temperature recuperation portion.

8. The small modular nuclear reactor of claim 7, wherein the low temperature recuperation portion comprises a low temperature recuperator and a compressor.

9. The small modular nuclear reactor of claim 4, wherein a portion of the energy conversion material flow is split into a high flow portion and a low flow portion.

10. The small modular nuclear reactor of claim 9, wherein the low flow portion comprises up to about 30% of the flow of energy conversion material and the high flow portion comprises up to about 70% of the flow of energy conversion material.

11. The small modular nuclear reactor of claim 9, wherein the high flow portion is directed to a reject heat exchanger.

12. The small modular nuclear reactor of claim 11, wherein the reject heat exchanger uses a heat exchange medium to dispose of reject heat and is further configured to cool the energy conversion flow material to a temperature of about 31 degrees C.

13. The small modular nuclear reactor of claim 12, wherein the heat exchange medium further flows through a reject heat cycle.

14. The small modular nuclear reactor of claim 12, wherein the reject heat cycle directs the flow of heat exchange medium to a bottoming cycle.

15. The small modular nuclear reactor of claim 14, wherein the bottoming cycle is configured to prove thermal energy to a co-generation application.

16. The small modular nuclear reactor of claim 14, wherein the small modular nuclear reactor is configured to deliver up to about 200 MWe of electricity and simultaneously deliver up to about 300 MWt of thermal energy from its reject heat stream.

17. A method of using the small modular nuclear reactor of claim 1.
